(19) United States
(12) Patent Application Publication
(10) Pub. No.: US 2006/0162885 A1
(43) Pub. Date: Jul. 27, 2006

(54) Paper transparentizing agent

(75) Inventors: Yuichi Tomoda, Fukui-shi (JP); Takashi Tanaka, Fukui-shi (JP); Yasutaka Sakai, Fukui-shi (JP)

Correspondence Address: FITCH, EVEN, TABIN & FLANNERY, P. O. BOX 65973, WASHINGTON, DC, 20035, US

(73) Assignee: Nicca Chemical Co., Ltd., Fukui-shi (JP)

(21) Appl. No.: 11/339,442

(22) Filed: Jan. 26, 2006

(30) Foreign Application Priority Data
Jan. 26, 2005 (JP) JP 2005-017878

(51) Int. Cl. D21H 23/00; B05B 5/00

(52) U.S. Cl. 162/164.6; 427/161

(57) ABSTRACT

A paper transparentizing agent, containing at least one amide compound selected from the group consisting of: an amide compound (A) that results from condensation of a monocarboxylic acid and at least one amine compound selected from the group consisting of polyalkylenepolyamines and alkanolamines; an amide compound (B) that results from condensation of at least one monocarboxylic acid, at least one polycarboxylic acid and at least one amine compound selected from the group consisting of polyalkylenepolyamines and alkanolamines; an amide compound (C) that results from condensation of a condensate and a monocarboxylic acid, the condensate resulted from condensation of at least one amine compound selected from the group consisting of polyalkylenepolyamines and alkanolamines, and epichlorohydrin or urea; and an amide compound (D) that results from condensation of a condensate, at least one monocarboxylic acid and at least one polycarboxylic acid, the condensate resulted from condensation of at least one amine compound selected from the group consisting of polyalkylenepolyamines and alkanolamines, and epichlorohydrin or urea.

### BACKGROUND OF THE INVENTION

1. Field of the Invention

The present invention relates to a paper transparentizing agent, and more specifically, the present invention relates to a paper transparentizing agent capable of imparting transparency to paper when it is applied to paper.

2. Related Background Art

Paper generally contains 40-50% air in its voids, and the difference in refractive index between the contained air and cellulose fiber constituting the paper makes it look white, giving the paper with opacity. For this reason, it is possible to obtain transparent paper by filling paper voids with a compound to penetrate paper, which has a refractive index similar to that of cellulose fiber. Transparent paper obtained in this way is used, for example, for tracing paper and windows of envelopes with a window.

Such envelopes with a window have generally been manufactured by cutting out a piece from an envelope and attaching a transparent film such as cellophane to the envelope so as to cover the hole created. Such a method, however, involves complicated processes, such as creation of a window and adhesion of a film, and thus has been inefficient.

In addition, envelopes with a window have also been manufactured in the following way: Resin (e.g., acrylic resin, rosin resin, polyester resin, urethane resin, petroleum hydrocarbon resin, polymer alicyclic compounds or wax) that is dissolved in an organic solvent is used as a paper transparentizing agent; the paper transparentizing agent is applied to a part of an envelope; and the part is heated to allow the resin to penetrate through paper to make the window part of the envelope transparent. However, resin used in such a method is not water-soluble. Even when it is water-soluble, only a limited amount of it will be dispersed or emulsified in water. It is therefore impossible to dissolve the resin even in alkaline water such as aqueous sodium hydroxide. For this reason, envelopes with a window obtained in this way are difficult to be recycled, and when used paper are collected, they need to be separated from newspaper or advertisement paper, thus increasing recycle costs. Moreover, if envelopes with a window obtained in this way are not completely separated from other used paper at this point, scum derived from resin pitch or wax is generated when removing a transparentizing agent from the envelopes with window using a pulper or the like. Accordingly, not only troubles during recycled paper making but also many problems, such that the recycled paper is made ink-repellent, have heretofore occurred.

For these reasons, studies have been made on a paper transparentizing agent, which uses resin other than the foregoing resin and is capable of providing transparent paper that is used, for example, for envelopes with a window. For example, Japanese Patent Laid-Open No.2002-327397 (Document 1) discloses a paper transparentizing agent containing an aqueous polyether compound with a specific structural formula having hydrocarbon groups or acyl groups and an alkylene oxide chain. Japanese Patent Laid-Open No.2003-306895 (Document 2) discloses a paper transparentizing agent containing an aqueous compound with a specific structural formula having alkoxyalkyl groups and an alkylene oxide chain. Furthermore, Japanese Patent Laid-Open No.2003-313800 (Document 3) discloses a paper transparentizing agent containing an aqueous compound with a specific structural formula having heterocycloalcohol residues and an alkylene oxide chain. These conventional transparentizing agents, however, have a low melting point and are water-soluble, and they are therefore poor in water resistance. For this reason, they have problems such that: they become white when water droplets are attached to them; and they melts when touched by sweaty hands in summer.

### SUMMARY OF THE INVENION

The present invention has been accomplished in view of the foregoing problems, and an object thereof is to provide a paper transparentizing agent capable of imparting excellent transparency and water resistance to paper as well as of achieving high paper recyclability.

The present inventors have diligently conducted studies in order to accomplish the foregoing object. As a result, they established that a paper transparentizing agent with a specific amide compound can be obtained, the paper transparentizing agent being capable of imparting excellent transparency and water resistance to paper as well as of achieving high paper recyclability. Thus, they perfected the present invention based on this knowledge.

Specifically, the paper transparentizing agent of the present invention is a paper transparentizing agent containing at least one amide compound selected from the group consisting of: an amide compound (A) that results from condensation of a monocarboxylic acid and at least one amine compound selected from the group consisting of polyalkylenepolyamines and alkanolamines; an amide compound (B) that results from condensation of at least one monocarboxylic acid, at least one polycarboxylic acid and at least one amine compound selected from the group consisting of polyalkylenepolyamines and alkanolamines; an amide compound (C) that results from condensation of a condensate and a monocarboxylic acid, the condensate resulted from condensation of at least one amine compound selected from the group consisting of polyalkylenepolyamines and alkanolamines, and epichlorohydrin or urea; and an amide compound (D) that results from condensation of a condensate, at least one monocarboxylic acid and at least one polycarboxylic acid, the condensate resulted from condensation of at least one amine compound selected from the group consisting of polyalkylenepolyamines and alkanolamines, and epichlorohydrin or urea.

As the paper transparentizing agent of the present invention, a paper transparentizing agent (i) is preferable that contains the amide compound (A) as the amide compound.

The paper transparentizing agent (i) may contain an acid salt of the amide compound (A) as the amide compound, the acid salt obtained by neutralizing the amide compound (A) with an acid.

Moreover, the paper transparentizing agent (i) may contain a condensate of the amide compound (A) as the amide compound, which is obtained by allowing the amide compound (A) and epichlorohydrin or urea to condense with each other.

As the paper transparentizing agent of the present invention, a paper transparentizing agent (ii) is preferable that contains the amide compound (B) as the amide compound.

The paper transparentizing agent (ii) may contain an acid salt of the amide compound (B) as the amide compound, the acid salt obtained by neutralizing the amide compound (B) with an acid.

Moreover, the paper transparentizing agent (ii) may contain a condensate of the amide compound (B) as the amide compound, the condensate obtained by allowing the amide compound (B) and epichlorohydrin or urea to condense with each other.

As the paper transparentizing agent of the present invention, a paper transparentizing agent (iii) is preferable that contains the amide compound (C) as the amide compound.

The paper transparentizing agent (iii) may contain an acid salt of the amide compound (C) as the amide compound, the acid salt obtained by neutralizing the amide compound (C) with an acid.

Furthermore, as the paper transparentizing agent of the present invention, a paper transparentizing agent (iv) is preferable that contains the amide compound (D) as the amide compound.

The paper transparentizing agent (iv) may contain an acid salt of the amide compound (D) as the amide compound, the acid salt obtained by neutralizing the amide compound (D) with an acid.

According to the present invention, it is possible to provide a paper transparentizing agent capable of imparting excellent transparency and water resistance to paper as well as of achieving high paper recyclability.

### DETAILED DESCRIPTION OF THE PREFERRED EMBODIMENTS

Hereinafter, the present invention will be described in detail in line with preferred embodiments thereof.

### Paper Transparentizing Agent (i)

A paper transparentizing agent (i) that is suitable as the paper transparentizing agent of the present invention will be first described. Specifically, the paper transparentizing agent (i) contains an amide compound (A) that results from condensation of a monocarboxylic acid and at least one amine compound selected from the group consisting of polyalkylenepolyamines and alkanolamines.

The monocarboxylic acids used for preparation of the paper transparentizing agent (i) are organic compound bearing one carboxylic group. For such monocarboxylic acids, fatty acids of 1 to 28 (more preferably 12 to 24) carbon atoms are preferable. If the number of carbon atoms exceeds the upper limit, paper recyclability tends to be reduced. Such monocarboxylic acids may be saturated or unsaturated, may be straight or branched and may have a cyclic structure. Specifically, examples of the monocarboxylic acids according to the present invention include straight-chain saturated aliphatic monocarboxylic acids, branched-chain saturated aliphatic monocarboxylic acids, saturated alicyclic monocarboxylic acid, straight-chain unsaturated aliphatic monocarboxylic acids, branched-chain unsaturated aliphatic monocarboxylic acids and aromatic monocarboxylic acids. Furthermore, as such monocarboxyic acids, monocarboxyic acids bearing functional groups such as hydroxyl or thiol groups may also be used.

Examples of such straight-chain saturated aliphatic monocarboxylic acids include formic acid, acetic acid, propionic acid, butyric acid, valeric acid, caproic acid, heptanoic acid, caprylic acid, nonanoic acid, capric acid, undecanoic acid, lauric acid, tridecanoic acid, myristic acid, pentadecanoic acid, palmitic acid, heptadecanoic acid, stearic acid, nonadecanoic acid, eicosanoic acid, behenic acid and tetracosanoic acid.

Examples of the foregoing branched-chain saturated aliphatic monocarboxylic acids include 2-methylpropanoic acid, 2-ethylpentanoic acid, 2-methylheptanoic acid, 2-ethylhexanoic acid, 2-ethyloctanoic acid, 2-methylundecanoic acid, 2-ethyltetradecanoic acid and 2-methylheptadecanoic acid.

Examples of the foregoing saturated alicyclic monocarboxylic acids include cyclobutanecarboxylic acid, cyclopentanecarboxylic acid, cyclohexanecarboxylic acid, cyclooctanecarboxylic acid, 2-cyclohexylethanoic acid, 3-cyclohexylpropanoic acid, 4-cyclohexylbutanoic acid, 6-cyclohexylhexanoic acid, 8-cyclohexyloctanoic acid, 12-cyclohexyldodecanoic acid and 16-cyclohexyltetradecanoic acid.

Examples of the foregoing straight-chain unsaturated aliphatic monocarboxylic acids include butenoic acid, pentenoic acid, hexenoic acid, heptenoic acid, octenoic acid, nonenoic acid, decenoic acid, undecenoic acid, dodecenoic acid, tetradecenoic acid, hexadecenoic acid, oleic acid, eicosenoic acid, dococenoic acid, tetracosenoic acid, linoleic acid, eleostearic acid, linolenic acid, parinaric acid, arachidonic acid, tariric acid, stearolic acid and behenolic acid.

Examples of the foregoing branched-chain unsaturated aliphatic monocarboxylic acids include 2-methyl-3-butenoic acid, 2-ethyl-5-hexenoic acid, 2-methyl-10-undecenoic acid, 2-ethyl-15-hexadecenoic acid, 2-methyl-22-tricosenoic acid and 2-ethyl-27-octacosenoic acid.

Furthermore, examples of the foregoing aromatic monocarboxylic acids include benzenecarboxylic acid (benzoic acid), phenylethanoic acid, 3-phenylpropanoic acid, 4-phenylbutanoic acid, 5-phenylpentanoic acid, 6-phenylhexanoic acid, 8-phenyloctanoic acid, 10-phenyldecanoic acid, 12-phenyldodecanoic acid, 18-phenyloctadecanoic acid, 24-phenyltetracosanoic acid, naphthalenecarboxylic acid, 4-phenylbenzenecarboxylic acid and 2-(carboxyphenyl)-2-phenyl propane.

Furthermore, examples of monocarboxylic acids bearing functional groups such as hydroxyl or thiol groups include glycolic acid, β-hydroxypropionic acid, gluconic acid, hydroxybenzoic acid, lactic acid, thiolactic acid, hydroxyacrylic acid, oxybutyric acid, glyceric acid, tropic acid, benzilic acid and salicylic acid.

The amine compound according to the present invention is at least one amine compound selected from the group consisting of polyalkylenepolyamines and alkanolamines.

For such polyalkylenepolyamines, amine compounds that have alkylene groups of 2 to 10 carbon atoms and two or more amines in their structure can be cited. Such polyalkylenepolyamines may be straight or branched, and examples thereof include ethylenediamine, propylenediamine, butylenediamine, hexamethylenediamine, diethylenetriamine, triethylenetetraamine and tetraethylenepentaamine.

In addition, for the foregoing alkanolamines, amine compounds, that is alkanolamines of 2 to 10 carbon atoms and containing one or more primary or secondary amines in their structure, can be cited. Such alkanolamines may be straight or branched, and examples thereof include ethanolamine, diethanolamine, isopropanolamine, diisopropanolamine, 3-aminopropanol, 4-aminobutanol, aminoethylethanolamine, aminopropylethanolamine, aminobutylethanolamine, aminohexylethanolamine, N-(hydroxyethyl)diethylenetriamine and N-(hydroxypropyl)diethylenetriamine.

In the present invention these amine compounds may be used singly or in combination of two or more.

The amide compound (A) according to the present invention can be obtained by condensation of the foregoing monocarboxylic acid and the foregoing amine compound.

The method of allowing the foregoing monocarboxylic acid and the foregoing amine compound to condense with each other is not particularly limited, and it is possible to use conventionally known methods. To be more specific, such an amide compound (A) can be obtained by, for example, allowing a condensation reaction (amidation reaction) to occur between the foregoing monocarboxylic acid and the foregoing amine compound in a reactor in the absence or presence of an acid catalyst (e.g., sulfuric acid or paratoluene sulfonic acid) at 130-250° C. When allowing this condensation reaction to proceed in this way, it is also possible to neutralize the resultant solution by the addition of acid in an amount equal to that of the amine compound remaining in the solution, depending on the molar ratio in the reaction or on the type of the amine compound. In the neutralization, in light of a favorable balance between paper recyclability and water resistance, the resultant solution is preferably neutralized while remaining about 25 mol % of amine in the amide compound intact in the condensation solution.

The molar ratio between monocarboxylic acid and amine compound used in such a condensation reaction is preferably in a range of 0.5:1 to 5:1, more preferably in a range of 1:1 to 4:1 (monocarboxylic acid:amine compound). If the molar ratio of the monocarboxylic acid in the condensation reaction is below the lower limit, it tends to be difficult to attach the resultant transparentizing agent to paper because of its reduced viscosity, whereas if it exceeds the upper limit, the resultant transparent paper tends to have a low transparency.

Examples of acids used for the foregoing neutralization process include sulfuric acid, hydrochloric acid, phosphoric acid, phosphorous acid and mono- or polycarboxylic acids. For such mono- or polycarboxylic acids, fatty acids of 1 to 28 carbon atoms are preferable. Such mono- or polycarboxylic acids may be saturated or unsaturated, may be straight or branched and may have a cyclic structure. Furthermore, mono- or polycarboxylic acids bearing functional groups such as hydroxyl or thiol may also be used. Examples of such mono- or polycarboxylic acids include formic acid, acetic acid, propionic acid, butyric acid, valeric acid, caproic acid, caprylic acid, capric acid, lauric acid, myristic acid, palmitic acid, stearic acid, isostearic acid, behenic acid, oleic acid, linoleic acid, linolenic acid, erucic acid, benzoic acid, naphthoic acid, lactic acid, 12-hydroxystearic acid, thioglycolic acid, hydroxybenzoic acid, salicylic acid, oxalic acid, malonic acid, succinic acid, maleic acid, adipic acid, suberic acid, sebacic acid, phthalic acid, isophthalic acid, terephthalic acid, tartaric acid, pyromellitic acid and polymellitic acid.

For the transparent paper obtained by treatment with the paper transparentizing agent (i) to have an increased transarency, the amide compound (A) obtained in this way is preferably an amide compound (A) that derived from both polyalkylenepolyamines and alkanolamines. For such an amide compound (A), an amide compound that results from condensation of a mixture (a start material) of a polyalkylpolyamine and an alkanolamine and a monocarboxylic acid, or an amide compound obtained by combining two different reaction mixtures: one resulted from condensation of a polyalkylenepolyamine and a monocarboxylic acid, and the other resulted from condensation of an alkanolamine and a monocarboxylic acid, may be used.

In such an amide compound (A) the mixing ratio between the amide compound that derived from polyalkylenepolyamides and the amide compound that derived from alkanolamines is preferably in a range of 5:95 to 50:50, more preferably in a range of 15:85 to 40:60 (mass ratio). If the mixing ratio (mass ratio) of the amide compound derived from polyalkylenepolyamines in the amide compound (A) is less than 5 in the foregoing range, the resultant paper transparentizing agent tends to penetrate through paper more slowly, whereas if it exceeds 50, the paper treated with the paper transparentizing agent tends to have a low transparency.

The amide compound (A) that results from such a condensation reaction preferably has an acid value of not greater than 100 mg KOH/g. If the acid value exceeds the upper limit, the resultant transparent paper tends to have a low transparency.

Furthermore, the resultant amide compound (A) preferably has an average molecular weight of 500 to 20,000. If the average molecular weight is below the lower limit, it tends to be difficult to attach the resultant paper transparentizing agent to paper because of its reduced viscosity, whereas if it exceeds the upper limit, the paper transparentizing agent tends to penetrate through paper poorly.

In this way it is possible to obtain the paper transparentizing agent (i) by allowing it to contain the amide compound (A).

In such a paper transparentizing agent (i) the amide compound (A) may also be contained as an acid salt, which is obtained by neutralizing the amide compound (A) with an acid.

The acids used for this neutralization process are similar to those used in the foregoing neutralization process. The foregoing mono- or polycarboxylic acids are preferably used in such a neutralization process because it is possible to produce fatty acid soap in a process of recycling of used paper attached with the paper transparentizing agent of the present invention and because they are expected to have an excellent effect of facilitating dissociation of fixed material from used paper.

The neutralization method employed in the present invention is not particularly limited, and it is possible to use conventionally known neutralization methods. Such a neutralization process is preferably carried out at around 60-150° C. In this neutralization process it is preferable to add acid in an amount of 0.1 to 1.2 equivalents per equivalent of total amine value of the amide compound (A). If the acid content exceeds the upper limit, the resultant transparent paper tends to have a low transparency.

Furthermore, in such a paper transparentizing agent (i) the amide compound (A) may also be contained as a condensate, which results from condensation of the amide compound (A) and epichlorohydrin or urea.

The method of allowing the amide compound (A) and epichlorohydrin or urea to condense with each other is not particularly limited, and it is possible to use conventional condensation methods. An example of such methods involves placing the amide compound (A) and urea in a reactor, and allowing a condensation reaction to occur between them at 140-170° C.

For the urea ratio in the condensation reaction between the amide compound (A) and urea, the molar ratio between urea and the amine compound used for the preparation of the amide compound (A) is preferably in a range of 0.1:1 to 1.2:1. If the urea ratio in the condensation reaction is below the lower limit, the resultant transparent paper tends to have a low transparency, whereas if it exceeds the upper limit, the resultant paper transparentizing agent tends to penetrate through paper poorly.

In addition, for the epichlorohydrin ratio in the condensation reaction between the amide compound (A) and epichlorohydrin, the molar ratio between epichlorohydrin and the amine compound used in the preparation of the amide compound (A) is preferably in a range of 0.1:1 to 1.2:1. If the epichlorohydrin ratio in the condensation reaction is below the lower limit, the resultant transparent paper tends to have a low transparency, whereas if it exceeds the upper limit, the resultant paper transparentizing agent tends to penetrate through paper poorly.

Thus, it is possible to obtain a condensate of the amide compound (A) by allowing the amide compound (A) to condense with epichlorohydrin or urea.

### Paper Transparentizing Agent (ii)

A paper transparentizing agent (ii) that is suitable as the paper transparentizing agent of the present invention contains an amide compound (B) that results from condensation of at least one monocarboxylic acid, at least one polycarboxylic acid and at least one amine compound selected from the group consisting of polyalkylenepolyamines and alkanolamines.

For such a monocarboxylic acid, monocarboxylic acids that are similar to those used for the preparation of the foregoing paper transparentizing agent (i).

In addition, the polycarboxylic acids according to the present invention are organic compounds bearing two or more carboxylic groups. For such polycarboxylic acids, fatty acids of 1 to 28 (more preferably 2 to 12) carbon atoms are preferable. If the number of carbon atoms exceeds the upper limit, the resultant transparent paper tends to have a low transparency. In addition, Such polycarboxylic acids may be saturated or unsaturated, may be straight or branched and may have a cyclic structure. Furthermore, polycarboxyic acids bearing functional groups such as hydroxyl or thiol groups may also be used.

Examples of usable polycarboxylic acids include oxalic acid, decanedicarboxylic acid, adipic acid, maleic acid, malonic acid, ethylmalonic acid, butylmalonic acid, dimethylmalonic acid, succinic acid, methylsuccinic acid, dimethylsuccinic acid, glutaric acid, methylglutaric acid, dimethylglutaric acid, sebacic acid, azelaic acid, pimelic acid, suberic acid, 1,11-undecanedicarboxylic acid, dodecanedicarboxylic acid, hexadecanedicarboxylic acid, 3-iso-octylhexanedicarboxylic acid, cyclohexanedicarboxylic acid, butanetricarboxylic acid, butanetetracarboxylic acid, citric acid, tricarbamic acid, phthalic acid, isophthalic acid, terephthalic acid, pyromellitic acid and polymellitic acid.

Furthermore, examples of polycarboxylic acids bearing functional groups such as hydroxyl or thiol groups include mercaptosuccinic acid, malic acid, tartaric acid, citric acid, isocitric acid and arocitric acid.

In addition, the polyalkylenepolyamines and alkanolamines according to the present invention are similar to those used for the preparation of the foregoing paper transparentizing agent (i).

The amide compound (B) according to the present invention can be obtained by condensation of at least one monocarboxylic acid, at least one polycarboxylic acid and the foregoing amine compound. Here, the condensation method employed in the present invention is similar to the method in which the monocarboxylic acid and the amine compound condense with each other, both of which are used for the preparation of the foregoing paper transparentizing agent (i).

The method of introducing the foregoing monocarboxylic acid and the foregoing polycarboxylid acid in such a condensation reaction is not particularly limited. The following introduction methods can be adopted, for example: a introduction method that uses a mixture of carboxylic acids obtained by mixing at least one of the foregoing monocarboxylic acids with at least one of the foregoing polycarboxylic acids; and an introduction method in which the foregoing polycarboxylic acid is first introduced to condense with the foregoing amine compound followed by the introduction of the foregoing monocarboxylic acid.

In such a condensation reaction the molar ratio between total carboxylic acid and amine compound is preferably in a range of 0.5:1 to 5:1, more preferably in a range of 1:1 to 4:1. If the molar ratio of total carboxylic acid is below the lower limit, it tends to be difficult to attach the resultant transparentizing agent to paper because of its reduced viscosity, whereas if it exceeds the upper limit, the resultant transparent paper tends to have a low transparency.

In addition, the molar ratio between the monocarboxylic acid and polycarboxylic acid used in such a condensation reaction is preferably in a range of 0.5:1 to 10:1 (monocarboxylic acid:polycarboxylic acid). If the molar ratio of monocarboxylic acid in this condensation reaction is below the lower limit, the paper transparentizing agent tends to penetrate through paper poorly, whereas if it exceeds the upper limit, the resultant paper tends to have a low transparency.

In addition, a specific example of the method in which the amide compound (B) is obtained by allowing the foregoing polycarboxylic acid and the foregoing amine compound to condense with each other to form a condensate and by introducing the foregoing monocarboxylic acid to condense with that condensate includes a method involving: first placing a monocarboxylic acid and an amine compound in a reactor to allow a condensation reaction to occur between them in the absence or presence of an acid catalyst (e.g., sulfuric acid or paratoluene sulfonic acid) at around 130-250° C. for about 1-5 hours, until at the end the acid value becomes 5 mg KOH/g or less; next cooling down the inside of the reactor to 100-150° C.; then introducing an monocarboxylic acid in the reactor; and allowing a condensation reaction to occur between the introduced monocarboxylic acid and the resultant condensate in the absence or presence of an acid catalyst (e.g., sulfuric acid or paratoluene sulfonic acid) at around 130-250° C. for about 1-5 hours.

For the transparent paper obtained by treatment with the paper transparentizing agent (ii) to have an increased transparency, the amide compound (B) is preferably an amide compound that derived from both polyalkylenepolyamines and alkanolamines. For such an amide compound (B), an amide compound that results from condensation of a mixture (a start material) of a polyalkylpolyamine and an alkanolamine, a monocarboxylic acid and a polycarboxylic acid, or an amide compound obtained by combining two different reaction mixtures: one resulted from condensation of a polyalkylenepolyamine, a monocarboxylic acid and a polycarboxylic acid, and the other resulted from condensation of an alkanolamine, a monocarboxylic acid and a polycarboxylic acid, may be used.

In such an amide compound (B) the mixing ratio between the amide compound that derived from polyalkylenepolyamines and the amide compound that derived from alkanolamines is preferably in a range of 5:95 to 50:50, more preferably in a range of 15:85 to 40:60 (mass ratio). If the mixing ratio (mass ratio) of the amide compound that derived from polyalkylenepolyamines in the amide compound (B) is less than 5 in the foregoing range, the resultant paper transparentizing agent tends to penetrate through paper more slowly, whereas if it exceeds 50, the paper treated with the paper transparentizing agent tends to have a low transparency.

The amide compound (B) obtained in this way preferably has an acid value of not greater than 100 mg KOH/g. If the acid value exceeds the upper limit, the resultant transparent paper tends to have a low transparency.

Furthermore, the resultant amide compound (B) preferably has an average molecular weight of 500 to 20,000. If the average molecular weight is below the lower limit, it tends to be difficult to attach the resultant paper transparentizing agent to paper because of its reduced viscosity, whereas if it exceeds the upper limit, the paper transparentizing agent tends to penetrate through paper poorly.

In this way it is possible to obtain the paper transparentizing agent (ii) by allowing it to contain the amide compound (B).

In such a paper transparentizing agent (ii) the foregoing amide compound (B) may also be contained as an acid salt, which is obtained by neutralizing the amide compound (B) with an acid.

The acids used for this neutralization process are similar to those used in the foregoing neutralization process. Among these acids the foregoing mono- or polycarboxylic acids are preferably used because it is possible to produce fatty acid soap in a process of recycling of used paper attached with the paper transparentizing agent of the present invention and because they are expected to have an excellent effect of facilitating dissociation of fixed material from used paper.

The neutralization method employed in the present invention is not particularly limited, and it is possible to use conventionally known neutralization methods. Such a neutralization process is preferably carried out at around 60-150° C. Thus, it is possible to obtain an acid salt of the amide compound (B) by neutralizing the amide compound (B) with an acid.

Furthermore, in the paper transparentizing agent (ii) the amide compound (B) may also be contained as a condensate, which results from condensation of the amide compound (B) and epichlorohydrin or urea.

In addition, the method of allowing the amide compound (B) and epichlorohydrin or urea to condense with each other is similar to the method for allowing the amide compound (A) to condense with epichlorohydrin or urea, used for the preparation of the foregoing paper transparentizing agent (i).

For the urea ratio in the condensation reaction between an amide compound and urea, the molar ratio between urea and the amine compound used for the preparation of the amide compound (B) is preferably in a range of 0.1:1 to 1.2:1. If the urea ratio in the condensation reaction is below the lower limit, the resultant transparent paper tends to have a low transparency, whereas if it exceeds the upper limit, the resultant paper transparentizing agent tends to penetrate through paper poorly.

For the epichlorohydrin ratio in the condensation reaction between the amide compound (B) and epichlorohydrin, the molar ratio between epichlorohydrin and the amine compound used in the preparation of the amide compound (B) is preferably in a range of 0.1:1 to 1.2:1. If the epichlorohydrin ratio in the condensation reaction is below the lower limit, the resultant transparent paper tends to have a low transparency, whereas if it exceeds the upper limit, the resultant paper transparentizing agent tends to penetrate through paper poorly.

### Paper Transparentizing Agent (iii)

A paper transparentizing agent (iii) that is suitable as the paper transparentizing agent of the present invention contains an amide compound (C) that results from condensation of a condensate and a monocarboxylic acid, the condensate resulted from condensation of at least one amine compound selected from the group consisting of polyalkylenepolyamines and alkanolamines and epichlorohydrin or urea.

Here, the method of allowing amine compounds and epichlorohydrin or urea to condense with each other will be first described.

The polyalkylenepolyamines, alkanolamines and monocarboxylic acids according to the present invention are similar to those described in the preparation of the foregoing paper transparentizing agent (i).

The method, which is used in the present invention, of allowing the foregoing amine compounds and epichlorohydrin or urea to condense with each other is not particularly limited, and it is possible to adopt conventional condensation methods. A specific example of the method in which the foregoing amine compound and epichlorohydrin condense with each other includes a method involving placing the foregoing amine compound in a reactor, adding epichlorohydrin to the reactor bit by bit at 70-100° C., and allowing a condensation reaction to occur between them at that temperature range.

Meanwhile, when using urea instead of epichlorohydrin, a specific example of such a condensation method includes a method involving placing the foregoing amine compound in a reactor, adding urea in the reactor bit by bit at 140-170° C., and allowing a condensation reaction to occur between them at that temperature range.

For the mixing ratio between the amine compound and epichlorohydrin or urea in this condensation reaction, it is preferable to use epichlorohydrin or urea in an amount of 0.2 to 1.2 equivalents per equivalent of total amine value of the amine compound. If the mixing ratio of epichlorohydrin or urea in the condensation reaction is below the lower limit, the resultant transparent paper tends to have a low transparency, whereas if it exceeds the upper limit, the resultant paper transparentizing agent tends to penetrate through paper poorly.

In this way it is possible to obtain the condensate according to the present invention by condensation of the foregoing amine compound and epichlorohydrin or urea.

Next, a method of allowing the condensate thus obtained and a monocarboxylic acid to condensate with each other will be described. The method of allowing the foregoing condensate and a monocarboxylic acid to condensate with each other is not particularly limited, and it is possible to use conventionally known condensation methods. An example of such methods include a method that involves adding a monocarboxylic acid to the foregoing condensate, and allowing a condensation reaction (amidation reaction) to occur between them in the absence or presence of an acid catalyst (e.g., sulfuric acid or paratoluene sulfonic acid) at 130-250° C.

In such a condensation reaction the molar ratio between the monocarboxylic acid and the amine compound used for the preparation of the foregoing condensate is preferably in a range of 0.5:1 to 5:1. If the molar ratio of the foregoing monocarboxylic acid in the condensation reaction is below the lower limit, it tends to be difficult to attach the resultant paper transparentizing agent to paper because of its reduced viscosity, whereas if it exceeds the upper limit, the resultant transparent paper tends to have a low transparency.

Thus, it is possible to obtain the amide compound (C) according to the present invention by allowing the foregoing condensate and a monocarboxylic acid to condense with each other.

For the transparent paper obtained by treatment with the paper transparentizing agent (iii) to have an increased transparency, the amide compound (C) is preferably an amide compound that results from condensation of a condensate, which is derived from both polyalkylenepolyamines and alkanolamines, and a monocarboxylic acid. For such an amide compound (C), an amide compound that results from a condensation reaction between a condensate and a monocarboxylic acid, the condensate obtained by condensation of a mixture (a start material) of a polyalkylpolyamine and an alkanolamine and epichlorohydrin or urea, or an amide compound obtained by combining two different reaction mixtures: one resulted from a condensation reaction between a condensate and a monocarboxylic acid, the condensate obtained by condensation of a polyalkylenepolyamine and epichlorohydrin or urea, and the other resulted from a condensation reaction between a condensate and a monocarboxylic acid, the condensate obtained by condensation of an alkanolamine and epichlorohydrin or urea, may be used.

In such an amide compound (C) the mixing ratio between an amide compound that results from condensation of a condensate, which is derived from polyalkylenepolyamines, and an amide compound that results from condensation of a condensate, derived from alkanolamines, and a monocarboxylic acid is preferably in a range of 5:95 to 50:50, more preferably in a range of 15:85 to 40:60 (mass ratio). If the mixing ratio (mass ratio) of the amide compound derived from polyalkylenepolyamines in such an amide compound (C) is less than 5 in the foregoing range, the resultant paper transparentizing agent tends to penetrate through paper more slowly, whereas if it exceeds 50, the resultant transparent paper tends to have a low transparency.

In addition, such an amide compound (C) preferably has an acid value of not greater than 100 mg KOH/g. If the acid value exceeds the upper limit, the resultant transparent paper tends to have a low transparency.

Furthermore, the obtained amide compound (c) preferably has an average molecular weight of 500 to 20,000. If the average molecular weight is below the lower limit, it tends to be difficult to attach the resultant paper transparentizing agent to paper because of its reduced viscosity, whereas if it exceeds the upper limit, the paper transparentizing agent tends to penetrate through paper poorly.

In this way it is possible to obtain the paper transparentizing agent (iii) by allowing it to contain the amide compound (C).

In addition, in such a paper transparentizing agent (iii) the amide compound (C) may also be contained as an acid salt of the amide compound (C), which is obtained by neutralizing it with an acid.

The acids used for this neutralization process are similar to those used in the foregoing neutralization process. Among acids used for this neutralization process the foregoing mono- or polycarboxylic acids are preferably used because it is possible to produce fatty acid soap in a process of recycling of used paper attached with the paper transparentizing agent of the present invention and because they are expected to have an excellent effect of facilitating dissociation of fixed material from used paper.

The neutralization method employed in the present invention is not particularly limited, and it is possible to use conventionally known neutralization methods. Such a neutralization process is preferably carried out at around 60-150° C. Thus, it is possible to obtain an acid salt of the amide compound (C) by neutralizing the amide compound (C) with an acid.

### Paper Transparentizing Agent (iv)

A paper transparentizing agent (iv) that is suitable as the paper transparentizing agent according to the present invention contains an amide compound (D) that results from condensation of a condensate, at least one monocarboxylic acid and at least one polycarboxylic acid, the condensate resulted from condensation of at least one amine compound selected from the group consisting of polyalkylenepolyamines and alkanolamines, and epichlorohydrin or urea.

The polyalkylenepolyamines, alkanolamines, monocarboxylic acids and polycarboxylic acids according to the present invention are similar to those described in the preparation of the foregoing paper transparentizing agents (i) and (ii). Furthermore, condensates obtained by condensation of the amine compounds according to the present invention and epichlorohydrin or urea are similar to those described in the preparation of the foregoing paper transparentizing agent (iii).

Moreover, the method of allowing the condensates according to the present invention to condense with at least one monocarboxylic acid and at least one polycarboxylic acid is not particularly limited, and it is possible to use conventionally known condensation methods as appropriate.

The method of introducing the foregoing monocarboxylic acids and the foregoing polycarboxylid acids in such a condensation reaction is not particularly limited. The following introduction methods can be adopted, for example: a introduction method that uses a mixture of carboxylic acids obtained by mixing at least one of the foregoing monocarboxylic acids with at least one of the foregoing polycarboxylic acids; and an introduction method in which the foregoing polycarboxylic acid is first introduced to condense with the foregoing amine compound followed by the introduction of the foregoing monocarboxylic acid.

In such a condensation reaction the molar ratio between total carboxylic acid used and the amine compound used for the preparation of a condensate is preferably in a range of 0.5:1 to 5:1, more preferably in a range of 1:1 to 4:1. If the molar ratio of total carboxylic acid in this condensation reaction is below the lower limit, it tends to be difficult to attach the resultant paper transparentizing agent to paper because of its reduced viscosity, whereas if it exceeds the upper limit, the resultant transparent paper tends to have a low transparency.

The molar ratio between the monocarboxylic acid and polycarboxylic acid used in such a condensation reaction is preferably in a range of 0.5:1 to 10:1 (monocarboxylic acid:polycarboxylic acid). If the molar ratio of the monocarboxylic acid in the condensation reaction is below the lower limit, the resultant paper transparentizing agent tends to penetrate through paper poorly, whereas if it exceeds the upper limit, the resultant transparent paper tends to have a low transparency.

Here, a detailed description will be provided for the method in which the foregoing polycarboxylic acid is introduced in a condensation reaction to condense with the foregoing condensate and then the foregoing monocarobylic acid is introduced to produce the amide compound (D) as a result of condensation.

First, a polycarboxylic acid and the foregoing condensate is placed into a reactor, allowing a condensation reaction to occur between them in the absence or presence of an acid catalyst (e.g., sulfuric acid or paratoluene sulfonic acid) at around 130-250° C. for about 1-5 hours, until at the end the acid value becomes 5 mg KOH/g or less. Next, after cooling down the inside of the reactor to around 100-150° C., a monocarboxylic acid is introduced in the reactor to allow a condensation reaction to occur in the absence or presence of an acid catalyst (e.g., sulfuric acid or paratoluene sulfonic acid) at around 130-250° C. for about 1-5 hours. The amide compound (D) can also be obtained in this way.

For the transparent paper obtained by treatment with the paper transparentizing agent (iv) to have an increased transparency, the amide compound (D) is preferably an amide compound obtained by using a condensate that derives from both polyalkylenepolyamines and alkanolamines. For such an amide compound (D), an amide compound that results in the following manner: a mixture of a polyalkylenepolyamine and an alkanolamine is prepared as a start material to condense with epichlorohydrin or urea to give a condensate; and the resultant condensate is allowed to condense with a monocarboxylic acid and a polycarboxylic acid, or an amide compound that results in the following manner: a condensate obtained by condensation of a polyalkylenepolyamine and epichlorohydrin or urea, and a condensate obtained by condensation of an alkanolamine and epichlorohydrin or urea are prepared; each condensate is allowed to condensate with a monocarboxylic acid and a polycarboxylic acid; and the resultant condensates are combined, may be used.

In such an amide compound (D) the mixing ratio between the amide compound that derived from polyalkylenepolyamines and the amide compound that derived from alkanolamines is preferably in a range of 5:95 to 50:50, more preferably in a range of 15:85 to 40:60 (mass ratio). If the mixing ratio (mass ratio) of the amide compound derived from polyalkylenepolyamines in the amide compound (D) is less than 5 in the foregoing range, the resultant paper transparentizing agent tends to penetrate through paper more slowly, whereas if it exceeds 50, the resultant transparent paper tends to have a low transparency.

Such an amide compound (D) preferably has an acid value of not greater than 100 mg KOH/g. If the acid value exceeds the upper limit, the resultant transparent paper tends to have a low transparency.

Furthermore, the resultant amide compound (D) preferably has an average molecular weight of 500 to 20,000. If the average molecular weight is below the lower limit, it tends to be difficult to attach the resultant paper transparentizing agent to paper because of its reduced viscosity, whereas if it exceeds the upper limit, the paper transparentizing agent tends to penetrate through paper poorly.

In this way it is possible to obtain the paper transparentizing agent (iv) by allowing it to contain the amide compound (D).

In such a paper transparentizing agent (iv) the foregoing amide compound (D) may also be contained as an acid salt of the amide compound (D), which is obtained by neutralizing it with an acid.

The acids used for this neutralization process are similar to those used in the foregoing neutralization process. Among these acids the foregoing mono- or polycarboxylic acids are preferably used because it is possible to produce fatty acid soap in a process of recycling of used paper attached with the paper transparentizing agent of the present invention and because they are expected to have an excellent effect of facilitating dissociation of fixed material from used paper.

The neutralization method employed in the present invention is not particularly limited, and it is possible to use conventionally known neutralization methods. Such a neutralization process is preferably carried out at around 60-150° C. Thus, it is possible to obtain an acid salt of the amide compound (D) by neutralizing the amide compound (D) with an acid.

Note that in the foregoing paper transparentizing agents (i) to (iv) of the present invention (hereinafter collectively referred to as “the paper transparentizing agent of the present invention”), one or more of the foregoing amide compounds (A) to (D) derived from polyalkylenepolyamines, and one or more of the foregoing amide compounds (A) to (D) derived from alkanolamines can be combined therein, when intending to combine amide compounds derived from polyalkylenepolyamines and amide compounds derived from alkanoalmines therein.

In addition, it is possible to add alcohol solvents or surfactants in the paper transparentizing agent of the present invention in small amounts in order to reduce their viscosity or to make them penetrate through paper well. Examples of the foregoing alcohol solvents include methanol, ethanol, propyl alcohol, ethylene glycol and diethylene glycol. Examples of the foregoing surfactants include nonionic agents conferring excellent permeability to paper (e.g., 9-mole ethylene oxide adduct of lauryl alcohol) and anionic surfactants conferring excellent permeability to paper (e.g., dioctylsulfosuccinate).

(Method of Using the Paper Transparentizing Agent of the Present Invention)

Preferred embodiments for the paper transparentizing agent of the present invention have been described. Hereinafter, methods of using the paper transparentizing agent of the present invention will be described.

The paper transparentizing agent of the present invention is applied to paper to penetrate through it. In this way it is possible to obtain non-sticky transparent paper with excellent transparency and paper recyclability. More specifically, it is possible to obtain transparent paper by applying the paper transparentizing agent of the present invention to at least one side of paper, heating, drying and leaving the paper at rest, and so on. In addition, the paper transparentizing agent of the present invention may be used singly or in combination of two or more.

Paper to which the paper transparentizing agent of the present invention can be applied is not particularly limited, and standard paper can be cited as a suitable example. Here the term “standard paper” means “acid-free paper” or “acid paper” generally used.

In addition, the method of applying the paper transparentizing agent of the present invention to paper is not particularly limited, and it is possible to use conventionally known methods including: methods using equipment such as a printer or bar coater; methods using rollers or brushes; or methods using sprays. In such a coating process the paper transparentizing agent of the present invention is preferably applied to paper in an amount of 20 to 100 wt % relative to the basis weight of paper.

In order to impart high water resistance to the resultant transparent paper, which is obtained by applying the paper transparentizing agent of the present invention to paper, water-soluble resin, such as a copolymer of maleic acid and any of oxidized starch, starch derivatives, polyvinyl alcohol and vinyl acetate, methylcellulose and acrylamide resin, may be applied to the transparent paper.

### EXAMPLES

Hereinafter, the present invention will be described more specifically based on Examples and Comparative Examples. However, the present invention is not limited to Examples described below.

### (Synthesis Example 1

Amide Compound (A-1):

Amide compound resulted from condensation of a monocarboxylic acid and a polyalkylenepolyamine)

First, a 500-ml four-necked flask equipped with a dewatering apparatus, a thermometer and a nitrogen gas inlet was prepared as a reaction vessel and charged with 71.0 g (0.5 mol) of triethylenetetraamine and 278 g (1.0 mol) of stearic acid (neutralization value: 201.8). Thereafter, the reaction vessel was heated while introducing nitrogen gas, thereby allowing triethylenetetraamine and stearic acid to condense with each other at 180-220° C. for about 3 hours, until at the end the acid value becomes 5 mg KOH/g or less. In this way an amide compound (A-1) was obtained.

### Synthesis Example 2

Amide Compound (B-1):

Amide compound resulted from condensation of a monocarboxylic acid, a polycarboxylic acid and a polyalkylenepolyamine)

First, a 500-ml four-necked flask equipped with a dewatering apparatus, a thermometer and a nitrogen gas inlet was prepared as a reaction vessel and charged with 77.4 g (0.75 mol) of diethylenetriamine and 73.1 g (0.50 mol) of adipic acid. Thereafter, the reaction vessel was heated while introducing nitrogen gas, thereby allowing diethylenetriamine and adipic acid to condense with each other at 180-220° C. for about 3 hours, until at the end the acid value becomes 1 mg KOH/g or less. Next, is after cooling down the inside of the reaction vessel, 139 g (0.5 mol) of stearic acid (neutralization value: 201.8) was placed in the reaction vessel at 130-150° C. while introducing nitrogen gas. Thereafter, the reaction vessel was heated while introducing nitrogen gas again, thereby allowing stearic acid and the resultant condensate to condense with each other at 180-220° C. for about 5 hours, until at the end the acid value becomes 5 mg KOH/g or less. In this way an amide compound (B-1) was obtained.

### Synthesis Example 3

Condensate of Amide Compound (A-2):

Condensate of an amide compound, which is obtained by allowing a monocarboxylic acid and a polyalkylenepolyamine to codensate with each other and allowing epichlorohydrin to condense with the resultant condensate)

First, a 500-ml four-necked flask equipped with a dewatering apparatus, a thermometer and a nitrogen gas inlet was prepared as a reaction vessel and charged with 18.3 g (0.125 mol) of triethylenetetraamine and 139 g (0.50 mol) of stearic acid. Thereafter, the reaction vessel was heated while introducing nitrogen gas, thereby allowing triethylenetetraamine and stearic acid to condense with each other at 180-220° C. for about 3 hours, until at the end the acid value becomes 1 mg KOH/g or less. In this way an amide compound (A-2) was obtained. Next, after cooling down the inside of the reaction vessel, 92.5 g (1.0 mol) of epichlorohydrin was added dropwise to the reaction vessel over 1 hour at 80-90° C. while introducing nitrogen gas, thereby allowing the foregoing amide compound (A-2) and epichlorohydrin to condense with each other for 3 hours. In this way the condensate of an amide compound (A-2) was obtained.

### Synthesis Example 4

Amide Compound (C-1):

Amide compound obtained by allowing a polyalkylenepolyamine and urea to condense with each other and allowing a monocarboxylic acid to condense with the resultant condensate)

First, a 500-ml four-necked flask equipped with a dewatering apparatus, a thermometer and a nitrogen gas inlet was prepared as a reaction vessel and charged with 18.3 g (0.5 mol) of diethylenetriamine and 15.0 g of urea (0.25 mol). Thereafter, the reaction vessel was heated while introducing nitrogen gas, thereby allowing diethylenetriamine and urea to condense with each other at 150-160° C. for 2 hours to form a condensate. Next, after cooling down the inside of the reaction vessel, 139 g (0.50 mol) of stearic acid was placed in the reaction vessel at 130-150° C. while introducing nitrogen gas. Thereafter, the reaction vessel was heated while introducing nitrogen gas again, thereby allowing the foregoing condensate and stearic acid to condense with each other at 180-190° C. for 3 hours, until at the end the acid value becomes 10 mg KOH/g or less. In this way an amide compound (C-1) was obtained.

### Synthesis Example 5

Acid Salt of an Amide Compound (B-2):

Acid salt of an amide compound, which is obtained by allowing a monocarboxylic acid, a polycarboxylic acid and a polyalkylenepolyamine to condense with one another and neutralizing the resultant condensate with an acid)

First, a 500-ml four-necked flask equipped with a dewatering apparatus, a thermometer and a nitrogen gas inlet was prepared as a reaction vessel and charged with 91.4 g (0.63 mol) of triethylenetetraamine and 73.1 g (0.50 mol) of adipic acid. Thereafter, the reaction vessel was heated while introducing nitrogen gas, thereby allowing triethylenetetraamine and adipic acid to condense with each other at 180-220° C. for about 3 hours, until at the end the acid value becomes 1 mg KOH/g or less. Next, after cooling down the inside of the reaction vessel, 34.8 g (0.125 mol) of stearic acid (neutralization value: 201.8) was placed in the reaction vessel at 130-150° C. while introducing nitrogen gas. Thereafter, the reaction vessel was heated while introducing nitrogen gas again, thereby allowing stearic acid and the resultant condensate to condense with each other at 180-220° for 2 hours, until at the end the acid value becomes 5 mg KOH/g or less. In this way an amide compound (B-2) was obtained. After cooling down the inside of the reaction vessel, 34.8 g (0.125 mol) of stearic acid (neutralization value: 201.8) was placed in the reaction vessel at 130-150° C. to neutralize the amide compound (B-2). In this way an acid salt of the amide compound (B-2) was obtained.

### Synthesis Example 6

Amide Compound (A-3):

Amide compound resulted from condensation of a monocaroxylic acid and an alkanolamine)

First, a 500-ml four-necked flask equipped with a dewatering apparatus, a thermometer and a nitrogen gas inlet was prepared as a reaction vessel and charged with 52.1 g (0.5 mol) of aminoethylethanolamine and 208.5 g (0.75 mol) of stearic acid (neutralization value: 201.8). Thereafter, the reaction vessel was heated while introducing nitrogen gas, thereby allowing aminoethylethanolamine and stearic acid to condense with each other at 180-220° C. for about 5 hours, until at the end the acid value becomes 5 mg KOH/g or less. In this way an amide compound (A-3) was obtained.

### Synthesis Example 7

Amide Compound (B-3):

Amide compound resulted from condensation of a monocaroxylic acid, a polycarboxylic acid and an alkanolamine)

First, a 500-ml four-necked flask equipped with a dewatering apparatus, a thermometer and a nitrogen gas inlet was prepared as a reaction vessel and charged with 104.2 g (1.0 mol) of aminoethylethanolamine and 73.1 g (0.50 mol) of adipic acid. Thereafter, the reaction vessel was heated while introducing nitrogen gas, thereby allowing aminoethylethanolamine and adipic acid to condense with each other at 180-220° C. for about 3 hours, until at the end the acid value becomes 1 mg KOH/g or less. Next, after cooling down the inside of the reaction vessel, 139 g (0.5 mol) of stearic acid (neutralization value: 201.8) was placed in the reaction vessel at 130-150° C. while introducing nitrogen gas. Thereafter, the reaction vessel was heated while introducing nitrogen gas again, thereby allowing stearic acid and the resultant condensate to condense with each other at 180-220° C. for about 5 hours, until at the end the acid value becomes 5 mg KOH/g or less. In this way an amide compound (B-3) was obtained.

### Synthesis Example 8

Amide Compound (B-4):

Amide compound resulted from condensation of a monocarboxylic acid, a polycarboxylic acid and an alkanolamine)

First, a 500-ml four-necked flask equipped with a dewatering apparatus, a thermometer and a nitrogen gas inlet was prepared as a reaction vessel and charged with 104.2 g (1.0 mol) of aminoethylethanolamine and 73.1 g (0.50 mol) of adipic acid. Thereafter, the reaction vessel was heated while introducing nitrogen gas, thereby allowing aminoethylethanolamine and adipic acid to condense with each other at 180-220° C. for about 3 hours, until at the end the acid value becomes 1 mg KOH/g or less. Next, after cooling down the inside of the reaction vessel, 69.5 g (0.25 mol) of stearic acid (neutralization value: 201.8) and 169 g (0.25 mol) of behenic acid (neutralization value: 166) were placed in the reaction vessel at 130-150° C. while introducing nitrogen gas. Thereafter, the reaction vessel was heated while introducing nitrogen gas again, thereby allowing stearic acid and behenic acid to condense with the resultant condensate at 180-220° C. for 5 hours, until at the end the acid value becomes 5 mg KOH/g or less. In this way an amide compound (B-4) was obtained.

### Synthesis Example 9

Acid Salt of an Amide Compound (B-5):

Acid salt of an amide compound, which is obtained allowing a monocarboxylic acid, a polycarboxylic acid and an alkanolamine to condense with one another and neutralizing the resultant condensate with an acid)

First, a 500-ml four-necked flask equipped with a dewatering apparatus, a thermometer and a nitrogen gas inlet was prepared as a reaction vessel and charged with 78.1 g (0.75 mol) of aminoethylethanolamine and 73.1 g (0.50 mol) of adipic acid. Thereafter, the reaction vessel was heated while introducing nitrogen gas, thereby allowing aminoethylethanolamine and adipic acid to condense with each other at 180-220° C. for about 3 hours, until at the end the acid value becomes 1 mg KOH/g or less. Next, after cooling down the inside of the reaction vessel, 69.5 g (0.25 mol) of stearic acid (neutralization value: 201.8) was placed in the reaction vessel at 130-150° C. while introducing nitrogen gas. Thereafter, the reaction vessel was heated while introducing nitrogen gas again, thereby allowing stearic acid and the resultant condensate to condense with each other at 180-220° for 5 hours, until at the end the acid value becomes 5 mg KOH/g or less. In this way an amide compound (B-5) was obtained. Next, after cooling down the inside of the reaction vessel, 169 g (0.25 mol) of behenic acid (neutralization value: 166) was placed in the reaction vessel at 130-150° C. to neutralize the amide compound (B-5). In this way an acid salt of the amide compound (B-5) was obtained.

### Synthesis Example 10

Amide Compound (B-6):

Amide compound resulted from condensation of a monocarboxylic acid, polycarboxylic acid and an amine compound consisting of a polyalkylenepolyamine and an alkanolamine)

First, a 500-ml four-necked flask equipped with a dewatering apparatus, a thermometer and a nitrogen gas inlet was prepared as a reaction vessel and charged with 10.3 g (0.1 mol) of diethylenetriamine, 41.3 g (0.4 mol) of aminoethylethanolamine, and 73.1 g (0.50 mol) of adipic acid. Thereafter, the reaction vessel was heated while introducing nitrogen gas, thereby allowing diethylenetriamine, aminoethylethanolamine and adipic acid to condense with one another at 180-220° C. for 3 hours, until at the end the acid value becomes 1 mg KOH/g or less. Next, after cooling down the inside of the reaction vessel, 166.8 g (0.6 mol) of stearic acid (neutralization value: 201.8) was placed in the reaction vessel at 130-150° C. while introducing nitrogen gas. Thereafter, the reaction vessel was heated while introducing nitrogen gas again, thereby allowing stearic acid and the resultant condensate to condense with each other at 180-220° C. for 2 hours, until at the end the acid value becomes 5 mg KOH/g or less. In this way an amide compound (B-6) was obtained.

### Example 1

The amide compound (A-1) prepared in Synthesis Example 1 was directly used as a paper transparentizing agent.

### Example 2

The amide compound (B-1) prepared in Synthesis Example 2 was directly used as a paper transparentizing agent.

### Example 3

The condensate of the amide compound (A-2) prepared in Synthesis Example 3 was directly used as a paper transparentizing agent.

### Example 4

The amide compound (C-1) prepared in Synthesis Example 4 was directly used as a paper transparentizing agent.

### Example 5

The acid salt of the amide compound (B-2) prepared in Synthesis Example 5 was directly used as a paper transparentizing agent.

### Example 6

Fifty parts by weight of the amide compound (B-1) prepared in Synthesis Example 2, and 50 parts by weight of the acid salt of the amide compound (B-2) prepared in Synthesis Example 5 were melted and mixed with each other to form a paper transparentizing agent to be used.

### Example 7

The amide compound (A-3) prepared in Synthesis Example 6 was directly used as a paper transparentizing agent.

### Example 8

The amide compound (B-3) prepared in Synthesis Example 7 was directly used as a paper transparentizing agent.

### Example 9

The amide compound (B-4) prepared in Synthesis Example 8 was directly used as a paper transparentizing agent.

### Example 10

The acid salt of the amide compound (B-5) prepared in Synthesis Example 9 was directly used as a paper transparentizing agent.

### Example 11

The amide compound (B-6) prepared in Synthesis Example 10 was directly used as a paper transparentizing agent.

### Example 12

Fifty parts by weight of the amide compound (B-3) prepared in Synthesis Example 7, and 50 parts by weight of the amide compound (B-1) prepared in Synthesis Example 2 were melted and mixed with each other to form a paper transparentizing agent to be used.

### Example 13

Seventy five parts by weight of the amide compound (B-5) prepared in Synthesis Example 9, and 25 parts by weight of the amide compound (C-1) prepared in Synthesis Example 4 were melted and mixed with each other to form a paper transparentizing agent to be used.

### Comparative Example 1

Paraffin Wax 115° F. (manufactured by Nippon Seiro Co., Ltd) was directly used as a paper transparentizing agent.

### Comparative Example 2

PEG6000 was directly used as a paper transparentizing is agent.

[Performance Evaluation of Paper Transparentizing Agents]

Sheets of transparent paper obtained by treatment with the paper transparentizing agents prepared in Examples and Comparative Examples in the following way were evaluated for their performance.

Preparation of Transparent Paper

Using a barcoater, the paper transparentizing agents prepared in Examples and Comparative Examples (those prepared in Examples 3 and 9 and Comparative Examples 1 and 2 had been subjected to a heat treatment (100°) and melted before use) were applied to the surface of each sheet of test paper with an opacity of 68% and a basis weight of 50 g/m², so that their active constituent becomes 35 g/m² (70 wt % with respect to each sheet). Subsequently, the resultant sheets of paper were dried at 105° C. for 60 seconds, and cooled down to room temperature to form sheets of transparent paper, each treated with different paper transparentizing agents prepared in Examples and Comparative Examples.

(1) Transparency Evaluation

The opacity (%) of each sheet of transparent paper was measured with REFLECTOMETER MODEL TC-ED (manufactured by Tokyo Denshoku Co., Ltd) in accordance with JIS P 8138(1976). The obtained result is shown in Table 1. Note that, the lower the value is, the more transparent the paper is.

(2) Water Resistance Evaluation

For water resistance evaluation, a droplet of water was dropped on the surface of each sheet of the transparent paper, and then was wiped off 1 minute after to observe the surface condition of each sheet to evaluate the degree of whiteness. The obtained result is shown in Table 1. Note that the evaluation criteria for the degree of whiteness are as follows:

(Evaluation Criteria)

A: Paper has no whiteness
B: Paper has a little degree of whiteness (still has a transparency)
C: Paper has a whiteness (no longer has transparency)
   (3) Paper Recyclability Evaluation

For paper recyclability evaluation, each sheet of the transparent paper was evaluated for the presence of undissociated matter. More specifically, a pulper was charged with 5 g of transparent paper, 90 g of 40° C. water and 5 g of aqueous sodium hydroxide (1 wt %), whereby a paper transparentizing agent was dissociated from the transparent paper. A pulp thus produced was then formed into paper with a basic weight of 50 g/m² to produce sample sheets. The appearance of the sample sheets was observed to evaluate for the presence of undissoicated matter. The obtained result is shown in Table 1. Note that the evaluation criteria for the presence of undissociated matter are as follows:

(Evaluation Criteria)

A: No undissociated matter is observed
B: A little amount of undissociated matter is observed

C: Undissociated matter is observed

TABLE 1

| | | | Presence of |
|---|---|---|---|
| | Opacity (%) | Whiteness | undissociated matter |
| | (Transparency) | (Water resistance) | (Paper recyclability) |
| Example 1 | 21.5 | A | B |
| Example 2 | 19.0 | A | B |
| Example 3 | 19.5 | A | B |
| Example 4 | 20.5 | A | B |
| Example 5 | 20.8 | A | A |
| Example 6 | 20.1 | A | A |
| Example 7 | 21.2 | A | B |
| Example 8 | 19.8 | A | B |
| Example 9 | 20.1 | A | B |
| Example 10 | 18.4 | A | A |
| Example 11 | 19.8 | A | B |
| Example 12 | 18.8 | A | B |
| Example 13 | 17.6 | A | A |
| Comparative | 27.0 | A | C |
| Example 1 | | | |
| Comparative | 23.5 | C | A |
| Example 2 | | | |

As can be seen from the results shown in Table 1, all sheets of transparent paper that resulted from the paper transparentizing agents prepared in Examples 1 to 13 were shown to offer excellent transparency and water resistance as well as high paper recyclability. In particular, sheets of transparent paper that resulted from the paper transparentizing agents prepared in Examples 5, 6, 10 and 13, where fatty acid salts of amide compounds were used, were shown to offer much higher paper recyclability. Moreover, sheets of transparent paper that resulted from the paper transparentizing agents prepared in Examples 11 to 13, which are derived from both polyalkylenepolyamines and polyalkanolamines as amine compounds, were more transparent than those resulted from paper transparentizing agents derived from one amine compound, which are prepared in other Examples.

### INDUSTRIAL APPLICABILITY

As described above, it is made possible to provide a paper transparentizing agent capable of imparting excellent transparency and water resistance to paper as well as of achieving high paper recyclability.

The paper transparentizing agent of the present invention is therefore useful as a paper transparentizing agent used for transparent paper processing (e.g., creation of a window in envelopes).

What is claimed is:

1. A paper transparentizing agent, containing at least one amide compound selected from the group consisting of:
an amide compound (A) that results from condensation of a monocarboxylic acid and at least one amine compound selected from the group consisting of polyalkylenepolyamines and alkanolamines;
an amide compound (B) that results from condensation of at least one monocarboxylic acid, at least one polycarboxylic acid and at least one amine compound selected from the group consisting of polyalkylenepolyamines and alkanolamines;
an amide compound (C) that results from condensation of a condensate and a monocarboxylic acid, the condensate resulted from condensation of at least one amine compound selected from the group consisting of polyalkylenepolyamines and alkanolamines, and epichlorohydrin or urea; and
an amide compound (D) that results from condensation of a condensate, at least one monocarboxylic acid and at least one polycarboxylic acid, the condensate resulted from condensation of at least one amine compound selected from the group consisting of polyalkylenepolyamines and alkanolamines, and epichlorohydrin or urea.

2. The paper transparentizing agent according to claim 1, containing the amide compound (A) as the amide compound.

3. The paper transparentizing agent according to claim 1, containing an acid salt of the amide compound (A) as the amide compound, which is obtained by neutralizing the amide compound (A) with an acid.

4. The paper transparentizing agent according to claim 1, containing a condensate of the amide compound (A) as the amide compound, which is obtained by allowing the amide compound (A) and epichlorohydrin or urea to condense with each other.

5. The paper transparentizing agent according to claim 1, containing the amide compound (B) as the amide compound.

6. The paper transparentizing agent according to claim 1, containing an acid salt of the amide compound (B) as the amide compound, which is obtained by neutralizing the amide compound (B) with an acid.

7. The paper transparentizing agent according to claim 1, containing a condensate of the amide compound (B) as the amide compound, which is obtained by allowing the amide compound (B) and epichlorohydrin or urea to condense with each other.

8. The paper transparentizing agent according to claim 1, containing the amide compound (C) as the amide compound.

9. The paper transparentizing agent according to claim 1, containing an acid salt of the amide compound (C) as the amide compound, which is obtained by neutralizing the amide compound (C) with an acid.

10. The paper transparentizing agent according to claim 1, containing the amide compound (D) as the amide compound.

11. The paper transparentizing agent according to claim 1, containing an acid salt of the amide compound (D) as the amide compound, which is obtained by neutralizing the amide compound (D) with an acid.
